(19) United States
(12) Patent Application Publication
(10) Pub. No.: US 2025/0276642 A1
(43) Pub. Date: Sep. 4, 2025

(54) CAMERA MONITOR SYSTEM WITH REAL-TIME TRAILER STATUS HMI

(71) Applicant: STONERIDGE ELECTRONICS AB, Solna (SE)

(72) Inventors: Gabriel Lepage, Royal Oak, MI (US); Troy Cooprider, White Lake, MI (US); John Kirwan, Troy, MI (US)

(21) Appl. No.: 19/068,090

(22) Filed: Mar. 3, 2025

Related U.S. Application Data
(60) Provisional application No. 63/560,410, filed on Mar. 1, 2024.

(51) Int. Cl. B60R 1/26; B60D 1/64; B60Q 1/22; B60Q 1/30; B60Q 1/34; B60Q 1/44; B60Q 1/56; B60R 1/29; G06T 11/00

(52) U.S. Cl. CPC B60R 1/26; B60D 1/64; G06T 11/00; B60Q 1/22; B60Q 1/30; B60Q 1/34; B60Q 1/44; B60Q 1/56; B60R 1/29; B60R 2300/105

(57) ABSTRACT

A method of displaying trailer status information for a tractor and a connected trailer, the method includes a) generating a signal from a trailer component from the connected trailer, the signal includes data related to a status of the trailer component, b) transmitting the data from the connected trailer to the tractor, and c) depicting the data on a display that includes a graphical representation of the connected trailer and a trailer component graphic indicative of the trailer component.

### CROSS-REFERENCE TO RELATED APPLICATION

The present disclosure claims priority to U.S. Provisional Application No. 63/560,410 filed Mar. 1, 2024.

### TECHNICAL FIELD

This disclosure relates to a camera monitor system (CMS) for a vehicle, and specifically, to a method for enhancing driver awareness concerning the status of various trailer components.

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras to provide an enhanced field of view to a vehicle operator. In some examples, the camera systems cover a larger field of view than a conventional mirror, or include views that are not fully obtainable via a conventional mirror.

Operating a commercial vehicle with a CMS provides an operator with improved safety over conventional mirrors, as the cameras can provide visibility in situations that mirrors cannot. However, whether mirrors and/or a CMS are incorporated into a commercial vehicle, operating a commercial vehicle remains challenging due to limited visibility due to the commercial vehicle's substantial length.

A typical commercial vehicle includes a tractor and connected trailer with numerous trailer components, such as brakes, lights, tires and various sensors. Operational status of these trailer components must be periodically checked (typically by visual inspection) to ensure safety and/or regulatory compliance, which can be time consuming. Furthermore, the trailer component status may change quickly after inspection and may go unnoticed by the operator.

### SUMMARY

In one exemplary embodiment, a method of displaying trailer status information for a tractor and a connected trailer, the method includes a) generating a signal from a trailer component from the connected trailer, the signal includes data related to a status of the trailer component, b) transmitting the data from the connected trailer to the tractor, and c) depicting the data on a display that includes a graphical representation of the connected trailer and a trailer component graphic indicative of the trailer component.

In a further embodiment of any of the above, the transmitting step includes the steps of b1) passing the data through a trailer controller, b2) subsequently passing the data through a trailer gateway, b3) subsequently passing the data through a trailer filter, b4) subsequently passing the data through a standard 7-wire tractor-trailer cable, b5) subsequently passing the data through a tractor filter, b6) subsequently passing the data through a tractor gateway, and b7) subsequently passing the data through a tractor controller.

In a further embodiment of any of the above, the method incudes a step of activating the trailer component with the trailer controller. Step a) is performed in response to the activating step.

In a further embodiment of any of the above, the tractor includes an integrated connector filter that includes a housing that encloses the tractor filter and provides a female connecter that is connected to the tractor-trailer cable. The tractor filter is connected to the tractor gateway.

In a further embodiment of any of the above, the tractor includes first and second rear-facing cameras respectively provided on first and second sides of the tractor. The first and second rear-facing cameras are configured to each capture rear-facing narrow and wide views along the tractor and the connected trailer. The tractor includes first and second displays respectively in communication with the first and second cameras and that are arranged on the first and second sides within a cabin of the tractor to illustrate in real time the narrow and wide views.

In a further embodiment of any of the above, the cabin includes a driver information display that is configured to be arranged in front of a driver and a secondary information display that is configured to be arranged adjacent to the driver. Step c) is performed on one of the first and second displays, the driver information display and the secondary information display.

In a further embodiment of any of the above, the method includes a step of recording the data from at least one of the tractor and the connected trailer.

In a further embodiment of any of the above, the trailer component includes at least one of an axle load sensor and a trailer load sensor, and the trailer component graphic is of at least one of an axle and a trailer cargo area.

In a further embodiment of any of the above, the trailer component includes a tire that has at least one of a pressure sensor and a temperature sensor, and the trailer graphic is of at least one of a tire and a tire inflator.

In a further embodiment of any of the above, the trailer component includes a trailer thermal conditioning unit that includes at least one of a cargo temperature sensor and a cargo humidity sensor, and the trailer graphic is of at least one of a thermometer and a liquid droplet.

In a further embodiment of any of the above, the trailer component includes at least one of a door position sensor and a door lock, and the trailer graphic is of at least one of a door and a lock.

In a further embodiment of any of the above, the trailer component includes trailer lights, and the trailer graphic is of at least one of a license plate light, a back-up light, a tail light, a brake light, a turn signal and a running light.

In a further embodiment of any of the above, the trailer component includes at least one of an ultrasonic sensor, a lidar sensor and a radar sensor, and the trailer graphic is of a proximity sensor.

In a further embodiment of any of the above, the trailer component includes at least one of a cargo camera, a trailer side rearview camera and a trailer center rearview camera, and the trailer graphic is of camera.

In another exemplary embodiment, a camera monitor system (CMS) for a tractor and a connected trailer includes first and second rear-facing cameras that are configured to be respectively provided on first and second sides of the tractor. The first and second cameras are configured to each capture rear-facing narrow and wide views along the tractor and the connected trailer. First and second displays are respectively in communication with the first and second cameras and configured to be respectively arranged on the first and second sides within a cabin of the tractor to illustrate in real time rear-facing the narrow and wide views. A driver information display is configured to be arranged in front of a driver. A secondary information display is configured to be arranged adjacent to the driver. A tractor controller is configured to receive a signal from a trailer component from the connected trailer, the signal includes data related to a status of the trailer component, and the tractor controller is configured to depict the data on one of the first and second display, the driver display and the secondary information display, the data includes a graphical representation of the connected trailer and a trailer component graphic indicative of the trailer component.

In a further embodiment of any of the above, the tractor controller is configured to depict the graphical representation and the trailer component graphic on the secondary information display.

In a further embodiment of any of the above, the CMS includes a data recorder that is configured to record the data from the connected trailer.

In a further embodiment of any of the above, the data recorder is in communication with the tractor controller, and the first and second cameras provide video data. The data recorder is configured to record the video data.

In a further embodiment of any of the above, the CMS includes an integrated connector filter that includes a housing that encloses a tractor filter and provides a female connecter. The tractor filter is in communication with the tractor controller and configured to receive the signal.

In a further embodiment of any of the above, the data is from at least three of the following groups: a) at least one of an axle load sensor and a trailer load sensor, and the trailer component graphic is of at least one of an axle and a trailer cargo area, b) a tire has at least one of a pressure sensor and a temperature sensor, and the trailer graphic is of at least one of a tire and a tire inflator, c) a trailer thermal conditioning unit includes at least one of a cargo temperature sensor and a cargo humidity sensor, and the trailer graphic is of at least one of a thermometer and a liquid droplet, d) at least one of a door position sensor and a door lock, and the trailer graphic is of at least one of a door and a lock, e) trailer lights, and the trailer graphic is of at least one of a license plate light, a back-up light, a tail light, a brake light, a turn signal and a running light, f) at least one of an ultrasonic sensor, a lidar sensor and a radar sensor, and the trailer graphic is of a proximity sensor, and g) at least one of a cargo camera, a trailer side rearview camera and a trailer center rearview camera, and the trailer graphic is of camera.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitor system (CMS) used to provide at least Class II and Class IV views.

FIG. 1B is a schematic top elevational view of a commercial truck with a CMS providing Class II (narrow angle), Class IV (wide angle), Class V and Class VI views.

FIG. 2A is a schematic view of the CMS and a vehicle cabin, including displays.

FIG. 2B schematically illustrates the vehicle cabin and an example arrangement of displays.

FIG. 3 illustrates an example architecture for communicating signals between a tractor and a connected trailer.

FIG. 4 is a schematic illustrating a connected trailer and various trailer components.

FIG. 5 is a display providing a human machine interface (HMI) depicting an example graphical representation of the connected trailer and various example trailer component graphics indicative of trailer components.

FIG. 6 is a display providing a HMI depicting another example graphical representation of the connected trailer and various example trailer component graphics indicative of trailer components

FIG. 7 illustrates an example HMI provided on one of the displays associated with the CMS after an initialization sequence performed using the trailer status check module and for which no active faults were found.

FIG. 8 illustrates the HMI after the initialization sequence performed using the trailer status check module and for which several active faults were found.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

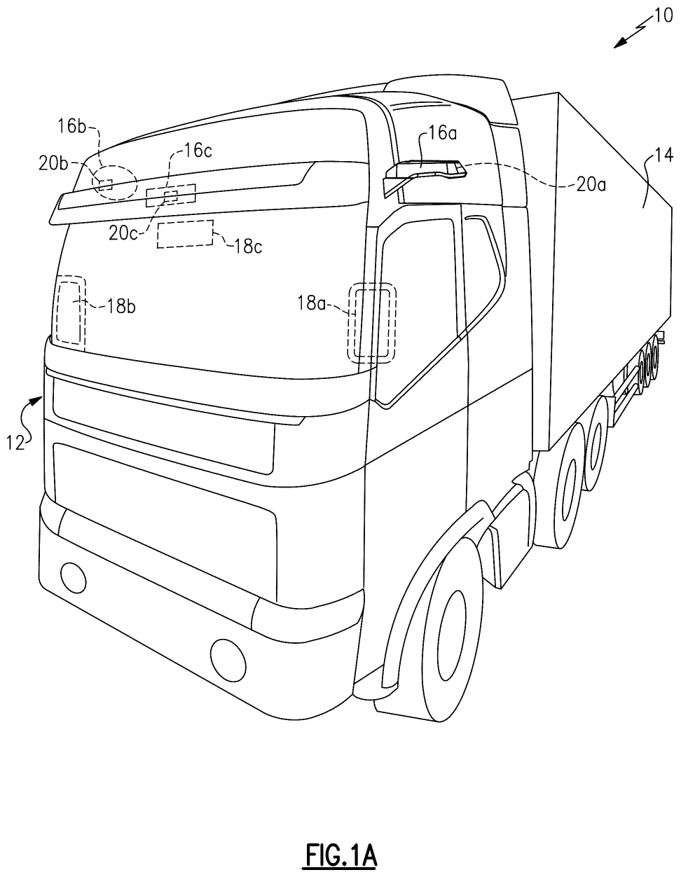

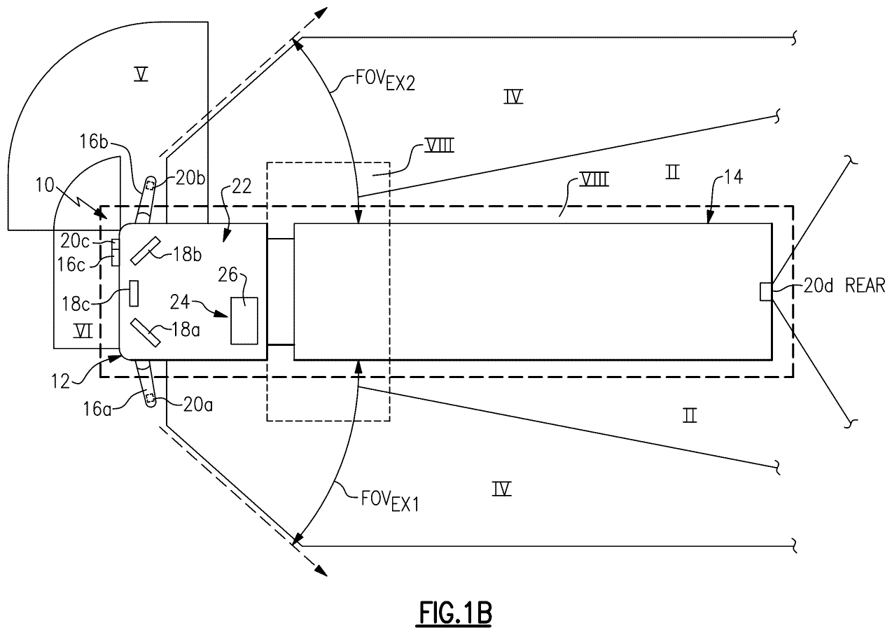

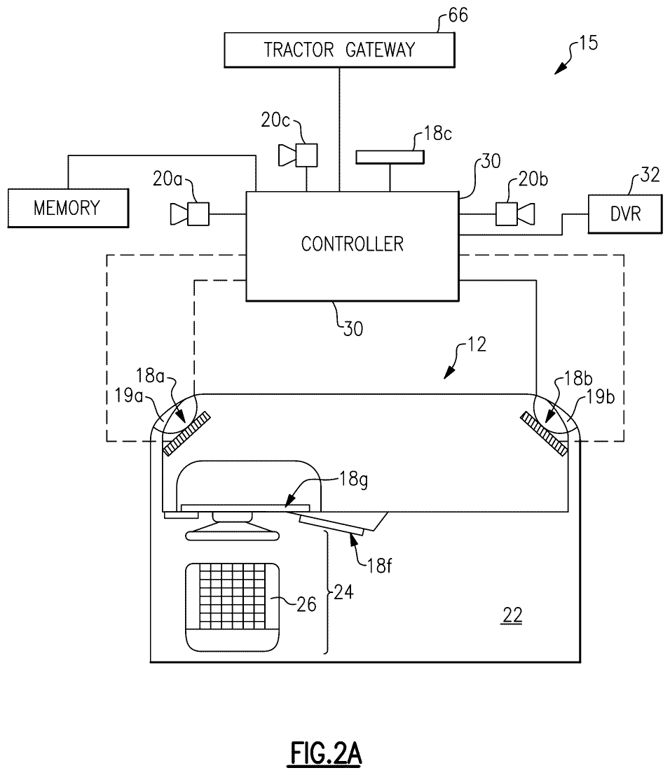

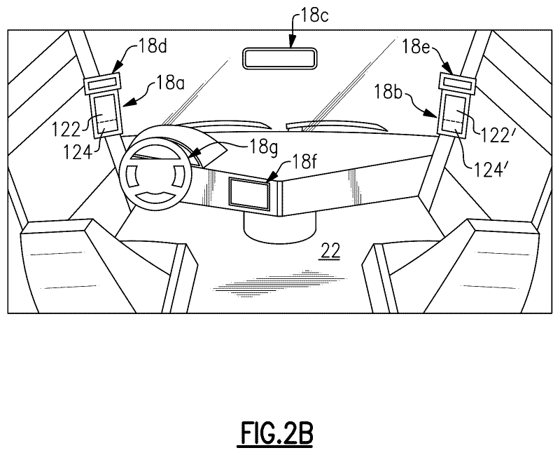

A schematic view of a commercial vehicle 10 is illustrated in FIGS. 1A and 1B. The vehicle 10 includes a vehicle cab or tractor 12 for pulling a connected trailer 14. It should be understood that the vehicle cab 12 and/or trailer 14 may be any configuration. Although a commercial truck is contemplated in this disclosure, the invention may also be applied to other types of vehicles, such as a box truck. The vehicle 10 incorporates a camera monitor system (CMS) 15 (FIG. 2A) that has driver and passenger side camera arms 16a, 16b (generally, “camera arm 16” or “wing”) mounted to the outside of the vehicle cab 12 to display views to the operator typically provided by mirrors. If desired, the camera arms 16a, 16b may include conventional mirrors integrated with them as well, although the CMS 15 can be used to entirely replace mirrors. In additional examples, each side can include multiple camera arms, each arm housing one or more cameras and/or mirrors.

Each of the camera arms 16a, 16b includes a base that is secured to, for example, the cab 12. A pivoting arm is supported by the base and may articulate relative thereto (i.e., manual or power fold). Fixed wings may also be used. At least one rearward facing camera 20a, 20b is arranged respectively within camera arms. It should also be understood that multiple cameras may be used in each camera arm 16a, 16b to provide these or other views, if desired. Each arm 16a, 16b may also provide a housing that encloses electronics that are configured to provide various features of the CMS 15.

The exterior cameras 20a, 20b each have an image capture unit that capture an exterior field of view FOV_{EX1}, FOV_{EX2} that each include at least one of the Class II (narrow angle) and Class IV (wide angle) views (FIG. 1B), which are legally prescribed views in the commercial trucking industry.

It is desirable to capture at least a portion of the trailer 14 in the field of view, for example, the side and/or end of the trailer, throughout vehicle operation. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera. For example, certain views may be prescribed in SAE J3155 or other regulations.

FIG. 2A is a schematic view of the vehicle 10 cabin including displays, and FIG. 2B illustrates an example layout of displays in the cabin. First and second video displays 18a, 18b are arranged on each of the driver and passenger sides within the vehicle cab 12 on or near the A-pillars 19a, 19b to display Class II (narrow angle) and Class IV (wide angle) views (e.g., Class II depicted at 122, 122′ above Class IV 124, 124′ in a portrait-style configuration, as shown in FIG. 2B) on its respective side of the vehicle 10, which provide rear facing side views along the vehicle 10 (e.g., including portions of the trailer) that are captured by the exterior cameras 20a, 20b.

If video of Class V and/or Class VI views are also desired, a camera housing 16c and camera 20c may be arranged at or near the front of the vehicle 10 to provide those views (FIG. 1B). The Class V view may be provided with the camera 20c located in the camera arm 16b. A third display 18c arranged within the cab 12 near the top center of the windshield can be used to display the Class V and Class VI views, which are toward the front of the vehicle 10, to the driver. The displays 18a, 18b, 18c face a driver region 24 within the cabin 22 where an operator is seated on a driver seat 26. The location, size and field(s) of view streamed to any particular display may vary from the configurations described in this disclosure and still incorporate the disclosed invention. For example, additional displays can be added near the first, second and third displays 18a, 18b, 18c, such as displays 18d, 18e, 18f (secondary information display), 18g (drive information display), shown in FIG. 2B, (generally, “display 18”).

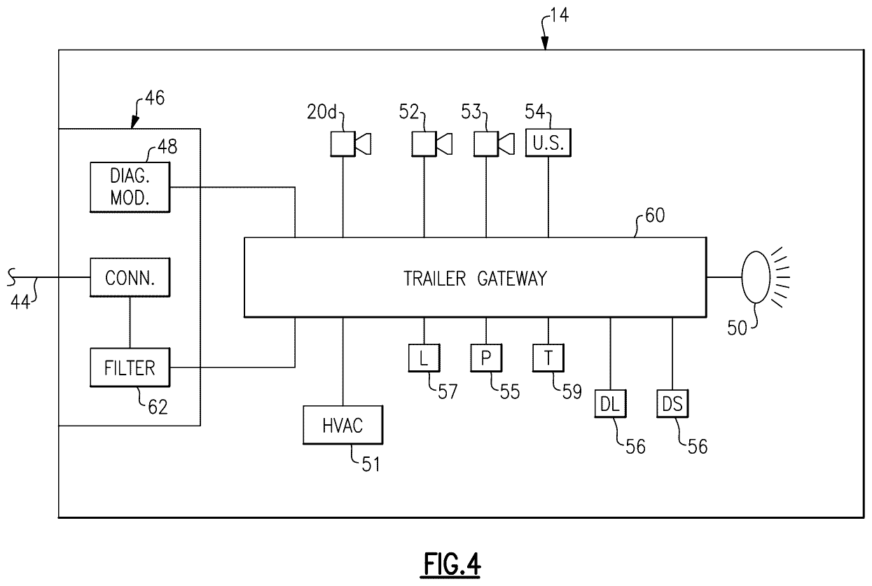

If video of Class VIII views is desired, camera housings can be disposed at the sides and rear of the vehicle 10 to provide fields of view including some or all of the Class VIII zones of the vehicle 10. As illustrated, the Class VIII view includes views immediately surrounding the trailer, and in the rear proximity of the vehicle including the rear of the trailer. In some cases, the Class VIII view is generated using a trailer mounted camera 20d. The trailer mounted camera 20d is a rear facing camera which provides a field of view behind the trailer. Rear-facing cameras 53 (FIG. 4) may also be provided on the sides of the trailer 14 toward the front. This rear view can be provided to one of the displays 18 within the vehicle cabin 22 as a rear view mirror replacement or as a rear view mirror supplement. This view is particularly beneficial as the trailer 14 may block some, or all, views provided by a conventional rear view mirror.

The CMS 15 is also configured to utilize the images from the cameras 20a, 20b, 20c, 20d (generally, “camera 20”) as well as images from other cameras that may be disposed about the vehicle or in communication with the vehicle to determine features of the vehicle, identify objects, and facilitate driver assistance features such as display overlays and semi-automated driver assistance systems.

The CMS 15 provides a tractor controller 30 having a memory, for example, and a tractor gateway 66, as shown in FIG. 2A. The displays 18, cameras 20 are in communication with the tractor controller 30. A digital video recorder (DVR) 32 or other data recorder may also be in communication with the tractor controller 30 for storing data from the vehicle, which may then be uploaded to the cloud or a fleet operator. The status of the trailer components, described below, may also be recorded on DVR 32.

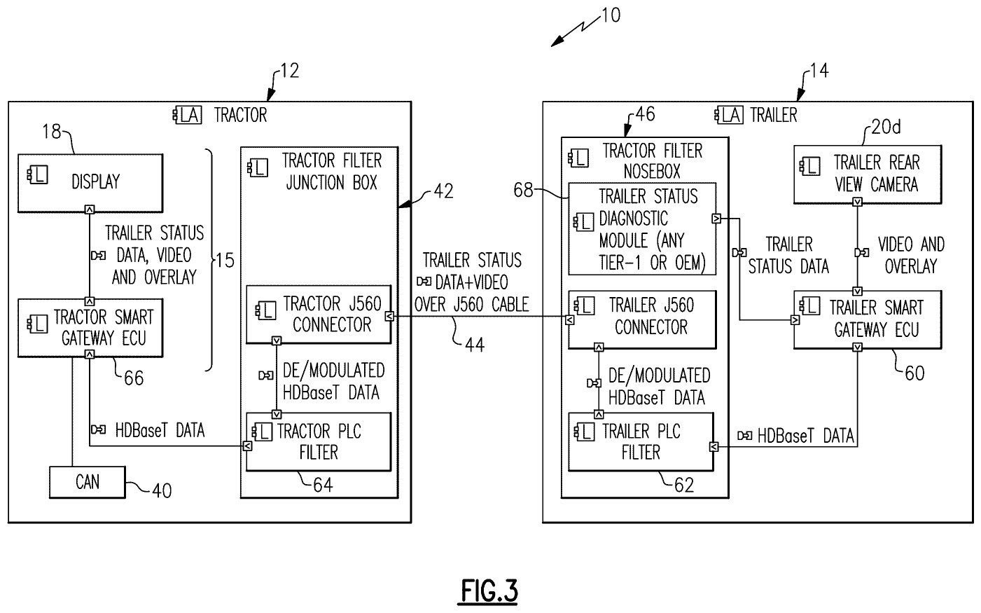

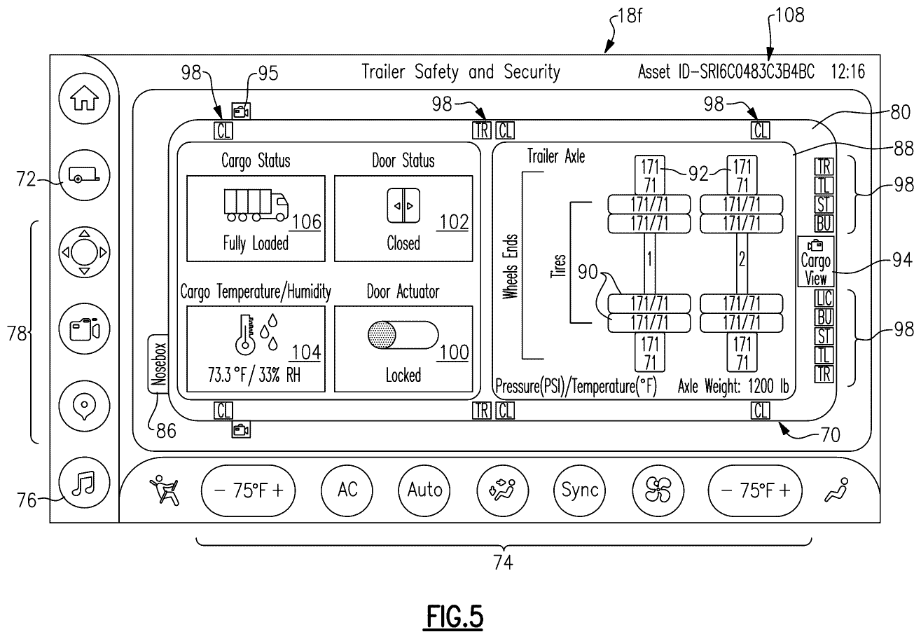

The CMS 15 provides a real-time trailer status human machine interface (HMI), shown in FIGS. 5-8, for visualizing smart trailer data transported via a connected trailer system schematically illustrated in FIG. 3. Previously, reading sensor data to determine status and/or functionality (operational or malfunctioning) required the driver to inspect trailer components visually and/or to use wireless device or specialized equipment to check a trailer component's status.

Data transfer between a tractor and a trailer is an emerging trend with limited existing application. It is currently accomplished via its own connection between the tractor and trailer. This connection can be either wired, or wireless. Existing truck and trailer electrical connections provide DC power and very low frequency signals from the truck to the trailer. For example, a standard J560 connection has seven pins which carry aux power, ground, reverse lights, tail lights, right turn (brake), left turn (brake) and electric brakes. Many trucks and trailers already include standard J560 female connectors mounted thereto.

A wired data communications architecture has been developed for transmitting a signal between the tractor and the connected trailer component over standard J560 connectors and a standard 7-pin tractor-trailer cable. One such architecture is disclosed in International Patent Application No. PCT/US22/34710, entitled “TRAILER CAMERA COMMUNICATIONS SYSTEM”, filed on Jun. 23, 2022 and incorporated herein by reference in its entirety. FIG. 3 illustrates a disclosed trailer component status monitoring system based upon such an architecture.

Referring to FIG. 3, the CMS 15 is arranged in the tractor 12 and receives data via the CAN bus 40. Data is transmitted between the tractor 12 and the trailer 14 over a standard 7-pin tractor trailer cable 44 interconnecting an integrated connector filter 42 on the tractor and a similar connector filter arranged in the trailer's nosebox 46, which also houses the trailer controller. The filters may be packaged, for example, as disclosed in International Patent Application No. PCT/US2024/036868, entitled “INTEGRATED CONNECTOR FILTER FOR TRUCK-TRAILER DATA COMMUNICATION” filed on Jul. 5, 2024, which is incorporated herein by reference in its entirety. Each integrated connector filter 42, 46 includes a housing enclosing the trailer filter and provides a female connecter connected to the tractor-trailer cable. Generally, the filters 62, 64 each receive data from a gateway and superimpose that data as low-amplitude, high-frequency signals onto at least one of a plurality of wires of the standard connector and cable (again, such as the J560 standard connectors and cables). Each filter also splits off the high-frequency signals sent by the other integrated connector filter and sends that data to a gateway 60, 66 on its associated truck or trailer. In this way, data from trailer components such as a rear camera 20d and other components can be transmitted to the tractor 12 with minimal modification to the trailer and over existing 7-pin wiring.

Referring to FIG. 4, various trailer components connected to the trailer gateway 60 are schematically illustrated. Example trailer components include the rear camera 20d, trailer lights 50, a thermal conditioning unit 51 (with temperature and/or humidity sensors), a cargo camera 52, trailer rear-facing side cameras 53, ultrasonic, lidar and/or radar sensor 54, a tire pressure sensor 55, a trailer door switch (opened/closed) sensor 56, an axle and/or cargo load sensor 57, a trailer door lock (opened/closed) sensor 58, and a tire temperature sensor 59.

Returning to FIG. 3, trailer sensor data is read from a controller area network (CAN) bus 40 on the trailer 14 where the trailer system interfaces with the trailer components via the CAN bus 40 and power cable. This data is then sent to the trailer controller which contains the trailer gateway module 60. The trailer gateway module 60 then tunnels that data via the HDBaseT data backbone which is decoded by the tractor mounted controller which will then provide that data to the CMS 15 and its display(s) 18 via the CAN bus 40.

Starting the tractor initializes the trailer connected components/sensors when the trailer status check module 68, which may be provided by the trailer controller, polls the data from the components/sensors and provides it to the trailer controller and trailer gateway 60. During the initialization stage the trailer status check module 68 provides configuration information which tells the tractor controller what trailer components/sensors are installed on a given trailer and enables the tractor to dynamically configure the displayed sensor data without driver interaction.

The trailer component is on/enabled via the trailer status check module 68 which acts as the interface to the CAN connected sensors which would be in charge of requesting information from the sensor modules. For a standalone variant, the trailer controller and trailer gateway 60 is in charge of maintaining the configuration information for a trailer 14 and providing to the tractor controller.

The disclosed system provides the driver with an early indicator of failures which would jeopardize safety for the driver and other motorists nearby. The disclosed system is not meant to replace the pre-trip inspection or Get Out And Look (GOAL) but does provide the driver (and fleets when a DVR is used) and early indication of potential safety issues and Federal Motor Vehicle Safety Standards (FMVSS) violations. In one example, a trailer status HMI 70 is provided to the display 18 (FIGS. 5-8), for example, driver information display 18g or secondary information display 18f, based upon the vehicle operating mode, for example, the transmission gear status. For example, the trailer status HMI 70 HMI will be displayed when the transmission is in a forward gear, but not displayed when the transmission is in a reverse gear.

In operation, the disclosure provides a human machine interface (HMI) for displaying trailer status information in a camera monitor system (CMS) for a tractor and a connected trailer. The trailer component is activated with the trailer controller, and generating a signal from a trailer component from the connected trailer, a signal is generated that includes data related to a status of the trailer component (e.g., functional, malfunction, a measured value, an operational state (e.g., locked/unlocked, opened/closed, etc.). The data is transmitted from the connected trailer 14 to the tractor 12, which includes, for example: passing the data through a trailer controller, subsequently passing the data through a trailer gateway 60, subsequently passing the data through a trailer filter 62, subsequently passing the data through a standard 7-wire tractor-trailer cable 44, subsequently passing the data through a tractor filter 64, subsequently passing the data through a tractor gateway 66, and subsequently passing the data through a tractor controller 30. Other types of architectures and methods of data transmission may be used with the disclosed connected trailer HMI.

The tractor controller 300 communicates with one or more displays to depict the data on a display 18 in an intuitive manner so the operator can quickly comprehend the status of the various trailer components. In the example, the display 18 includes a graphical representation of the connected trailer (e.g., a rectangle that represents the trailer) and one or more trailer component graphic indicative of the trailer component, which is positioned on the graphical representation at a location that generally corresponds to the actual location of the trailer component on the trailer. As shown in the examples in FIGS. 5-8, the right side of the rectangle represents the rear of the trailer, the left side of the rectangle represents the front of the trailer, and the top and bottom sides of the rectangle respectively represent the right and left sides of the trailer.

In the example, the secondary information display (SID) 18f is used, which is may be a touchscreen display arranged next to and within reach of the operator. Typically, the SID 18f is also provided with cabin thermal conditioning system control icons 74, radio control icon(s) 76, and other control icon(s) 78, such as navigation. A trailer icon 72 may be provided on the SID 18f for displaying the connected trailer HMI 70 shown in FIGS. 5-8.

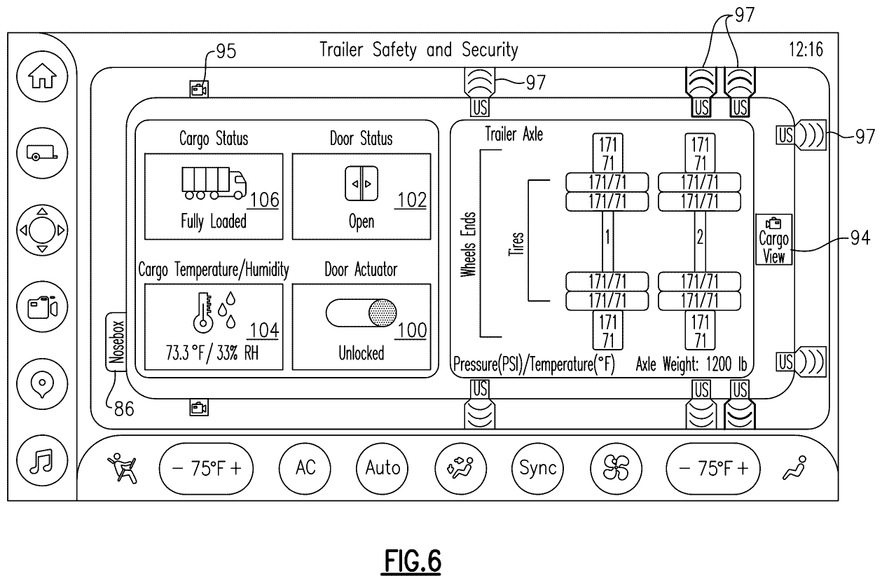

In the examples shown in FIGS. 5-8, the trailer components are represented by trailer component graphics arranged on the graphical representation of the connected trailer. In one example, if the trailer component graphic is green, then the represented trailer component is functioning as desired. Conversely, if the trailer component is malfunctioning or not delivering a signal as expected, then the trailer component graphic is red (see, e.g., FIGS. 6-8). The nosebox 46 is represented by a nosebox graphic 86. Providing the status of the nosebox 46 provides verification that the trailer components are being monitored properly and the trailer 14 is hooked up to the tractor 12 by the cable 44. The trailer identification then may also be provided at 108.

The graphics for the axles and tires may be arranged in a visually intuitive group 88. The trailer component associated with this group 88 includes at least one of an axle load sensor 57 and a trailer load sensor, and the trailer component graphic is of at least one of an axle (vertical bars connecting dual wheel/tire graphics) and a trailer cargo area 106. In the example, the axle load is provided numerically. The trailer component includes a tire having at least one of a pressure sensor 55 and a temperature sensor 59 with the trailer graphic provided as at least one of a tire 90 and a tire inflator 92. Pressures and temperatures may be provided within the graphic for the associated tire and/or tire inflator.

For refrigerated or heated trailers, the trailer component includes a trailer thermal conditioning unit 51 that has at least one of a cargo temperature sensor and a cargo humidity sensor. The trailer graphic in this example is of at least one of a thermometer and a liquid droplet (shown at 104), but other graphics may be used or just numerical values provided.

It may be useful to provide the status of the trailer doors. To this end, the trailer component includes at least one of a door position sensor 56 (opened/closed) and a door lock sensor 58 (locked/unlocked). The trailer graphic is of at least one of a door 102 and a lock 100, which are provided “forward” of the group 88, although these graphics may be provided at the “back” of the graphical representation of the trailer 80, if desired.

Verifying that the trailer's lights are operating is important. The trailer component includes trailer lights 50, which include a license plate light, a back-up light, a tail light, a brake light, a turn signal and a running light. The trailer graphic is of light at its location on the trailer so that it can be easily found by the operator in case a malfunction (red graphic) is indicated. The light graphics 98 include a license plate light (LIC), a back-up light (BU), a tail light (TL), a brake light (ST), a turn signal light (TR) and a running light (CL).

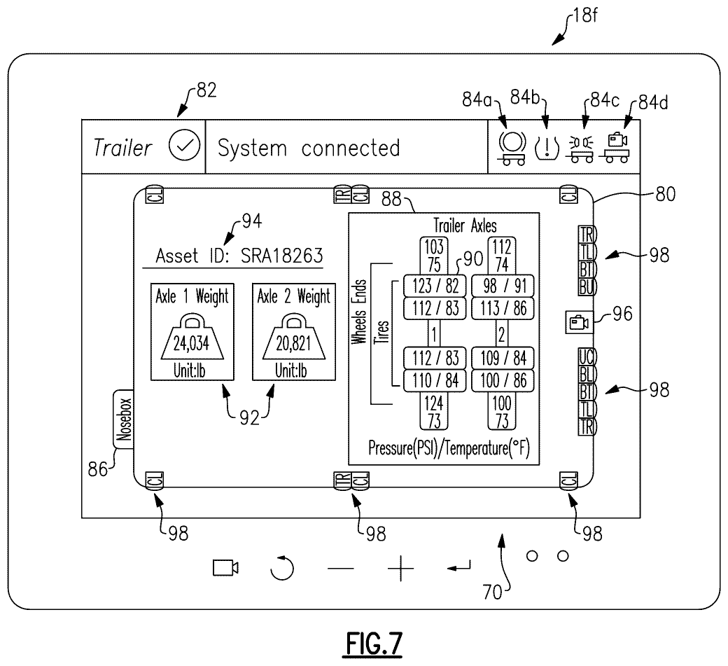

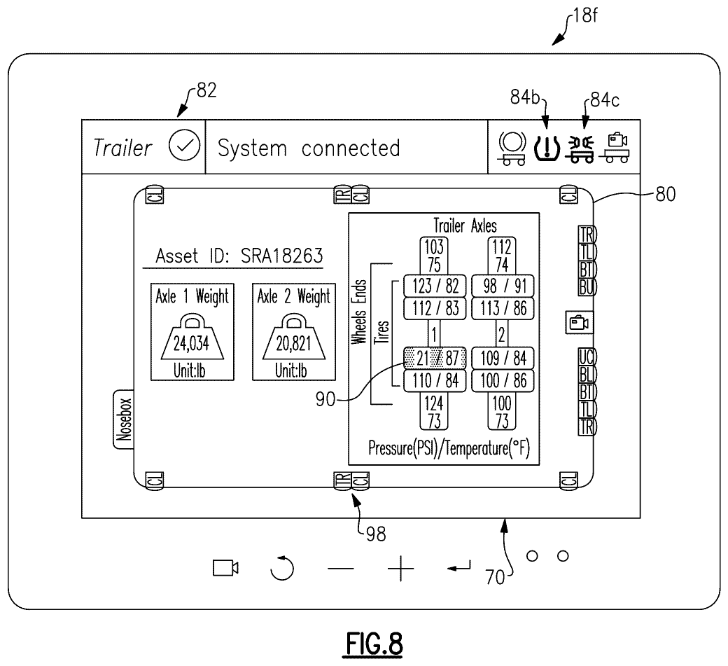

The trailer component includes at least one of a cargo camera 52, a trailer side rearview camera 53 and a trailer center rearview camera 20d. The trailer graphic is of camera at its location 94, 95, 96 (FIGS. 7 and 8). Referring to FIG. 6, where proximity sensors 54 are used on the trailer 14, the trailer component includes at least one of an ultrasonic sensor (US), a lidar sensor (LI; not shown) and a radar sensor (RA; not shown), and the trailer graphic is of a proximity sensor 97.

FIG. 7 illustrates another example human machine interface (HMI) provided on one of the displays (e.g., display 18f) after an initialization sequence is performed using the trailer status check module 68 and for which no active faults were found. The displayed data is part of a graphical representation 80 of the connected trailer, which depicts trailer component status in an intuitive manner, but with fewer features than shown in FIGS. 5 and 6. The graphical representation 80 also includes symbols or icons of various, individual trailer components (e.g., nosebox 86, tires 90, axles 92, rear camera 96, trailer lights 98). Tire and wheel end pressures and temperatures are grouped together at 88 in an intuitive manner, and trailer axle loads 92 may also be indicated.

Like the examples shown in FIGS. 5 and 6, the individual trailer components are shown in the general vicinity of where each component is located, and their individual status is indicated (e.g., green (no fault), yellow (mid-level priority fault), red (high-level priority fault). To simplify driver information assimilation, the overall trailer system condition 82 is indicated as a top-level trailer status, and subsystem status indicators provide a trailer status summary for various trailer subsystems (e.g., ABS 84a, tire pressure 84b, trailer lighting 84c, video feeds 84d).

FIG. 8 illustrates the HMI after the initialization sequence performed using the trailer status check module 68 and for which several active faults were found (e.g., low tire pressure and a malfunctioning running light).

The disclosed system effectively prevents FMVSS road violations by increasing the detection capability of driver that something is wrong with brakes, lights, tires (BLT) by providing live sensor data, operational status as well as fault information on the in-cab display.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of displaying trailer status information for a tractor and a connected trailer, the method comprising:
a) generating a signal from a trailer component from the connected trailer, the signal including data related to a status of the trailer component;
b) transmitting the data from the connected trailer to the tractor; and
c) depicting the data on a display including a graphical representation of the connected trailer and a trailer component graphic indicative of the trailer component.

2. The method of claim 1, wherein the transmitting step comprises the steps of:
b1) passing the data through a trailer controller;
b2) subsequently passing the data through a trailer gateway;
b3) subsequently passing the data through a trailer filter;
b4) subsequently passing the data through a standard 7-wire tractor-trailer cable;
b5) subsequently passing the data through a tractor filter;
b6) subsequently passing the data through a tractor gateway; and
b7) subsequently passing the data through a tractor controller.

3. The method of claim 2, comprising a step of activating the trailer component with the trailer controller, step a) is performed in response to the activating step.

4. The method of claim 2, wherein the tractor includes an integrated connector filter including a housing enclosing the tractor filter and providing a female connecter connected to the tractor-trailer cable, the tractor filter connected to the tractor gateway.

5. The method of claim 1, wherein the tractor includes first and second rear-facing cameras respectively provided on first and second sides of the tractor, the first and second rear-facing cameras configured to each capture rear-facing narrow and wide views along the tractor and the connected trailer, the tractor includes first and second displays respectively in communication with the first and second cameras and that are arranged on the first and second sides within a cabin of the tractor to illustrate in real time the narrow and wide views.

6. The method of claim 5, wherein the cabin includes a driver information display configured to be arranged in front of a driver and a secondary information display configured to be arranged adjacent to the driver, wherein step c) is performed on one of the first and second displays, the driver information display and the secondary information display.

7. The method of claim 5, comprising a step of recording the data from at least one of the tractor and the connected trailer.

8. The method of claim 1, wherein the trailer component includes at least one of an axle load sensor and a trailer load sensor, and the trailer component graphic is of at least one of an axle and a trailer cargo area.

9. The method of claim 1, wherein the trailer component includes a tire having at least one of a pressure sensor and a temperature sensor, and the trailer graphic is of at least one of a tire and a tire inflator.

10. The method of claim 1, wherein the trailer component includes a trailer thermal conditioning unit including at least one of a cargo temperature sensor and a cargo humidity sensor, and the trailer graphic is of at least one of a thermometer and a liquid droplet.

11. The method of claim 1, wherein the trailer component includes at least one of a door position sensor and a door lock, and the trailer graphic is of at least one of a door and a lock.

12. The method of claim 1, wherein the trailer component includes trailer lights, and the trailer graphic is of at least one of a license plate light, a back-up light, a tail light, a brake light, a turn signal and a running light.

13. The method of claim 1, wherein the trailer component includes at least one of an ultrasonic sensor, a lidar sensor and a radar sensor, and the trailer graphic is of a proximity sensor.

14. The method of claim 1, wherein the trailer component includes at least one of a cargo camera, a trailer side rearview camera and a trailer center rearview camera, and the trailer graphic is of camera.

15. A camera monitor system (CMS) for a tractor and a connected trailer, comprising:
first and second rear-facing cameras configured to be respectively provided on first and second sides of the tractor, the first and second cameras configured to each capture rear-facing narrow and wide views along the tractor and the connected trailer;
first and second displays respectively in communication with the first and second cameras and configured to be respectively arranged on the first and second sides within a cabin of the tractor to illustrate in real time rear-facing the narrow and wide views;
a driver information display configured to be arranged in front of a driver;
a secondary information display configured to be arranged adjacent to the driver; and
a tractor controller configured to receive a signal from a trailer component from the connected trailer, the signal including data related to a status of the trailer component, and the tractor controller configured to depict the data on one of the first and second display, the driver display and the secondary information display, the data including a graphical representation of the connected trailer and a trailer component graphic indicative of the trailer component.

16. The CMS of claim 15, wherein the tractor controller is configured to depict the graphical representation and the trailer component graphic on the secondary information display.

17. The CMS of claim 15, comprising a data recorder configured to record the data from the connected trailer.

18. The CMS of claim 17, wherein the data recorder is in communication with the tractor controller, and the first and second cameras providing video data, the data recorder configured to record the video data.

19. The CMS of claim 15, comprising an integrated connector filter including a housing enclosing a tractor filter and providing a female connecter, the tractor filter in communication with the tractor controller and configured to receive the signal.

20. The CMS of claim 15, wherein the data is from at least three of the following groups:
a) at least one of an axle load sensor and a trailer load sensor, and the trailer component graphic is of at least one of an axle and a trailer cargo area;
b) a tire having at least one of a pressure sensor and a temperature sensor, and the trailer graphic is of at least one of a tire and a tire inflator;
c) a trailer thermal conditioning unit including at least one of a cargo temperature sensor and a cargo humidity sensor, and the trailer graphic is of at least one of a thermometer and a liquid droplet;
d) at least one of a door position sensor and a door lock, and the trailer graphic is of at least one of a door and a lock;
e) trailer lights, and the trailer graphic is of at least one of a license plate light, a back-up light, a tail light, a brake light, a turn signal and a running light;
f) at least one of an ultrasonic sensor, a lidar sensor and a radar sensor, and the trailer graphic is of a proximity sensor; and
g) at least one of a cargo camera, a trailer side rearview camera and a trailer center rearview camera, and the trailer graphic is of camera.
